(19) United States
(12) Patent Application Publication
(10) Pub. No.: US 2010/0302950 A1
(43) Pub. Date: Dec. 2, 2010

(54) Timer adjustment for load control

(76) Inventor: Ray R. Zhao, Naperville, IL (US)

Correspondence Address: Docket Administrator (Room 2F-192);Alcatel-Lucent USA Inc., 600 Mountain Avenue, Murray Hill, NJ, 07974-0636, US

(21) Appl. No.: 12/455,216

(22) Filed: May 30, 2009

(51) Int. Cl. H04W 72/04; H04L 12/26

(52) U.S. Cl. 370/242; 370/329

(57) ABSTRACT

Method and apparatus embodiments are provided for dynamical adjusting a retry service request timer associated with User Equipment (UE) responsive to a service request based on a current load. In one embodiment, a method includes receiving a service request, and modifying a timer value associated with a User Equipment (UE) responsive to the service request based on a current load. The timer value is indicative of a period the UE is to wait before making a next service request. The timer value may be modified based on a leaky bucket algorithm. When the current load is indicative of an overload condition, the timer value is increased. For example, when the total number of service request establishment failures is above the high water mark, the timer value may be is increased. The timer value may be communicated to the UE.

### FIELD OF THE INVENTION

The invention generally relates to telecommunications. More particularly, this invention relates to wireless communication systems and providing of high availability radio access.

### BACKGROUND INFORMATION

Wireless communication systems are in widespread use. Typical arrangements provide wireless communication capabilities to mobile stations such as cell phones within particular geographic regions. The areas of coverage are typically divided into cells that are each served by at least one base station transceiver. A wireless link between a mobile station and the base station transceiver provides the mobile station with access to the wireless communication network

The base station transceiver communicates with one or more portions of the wireless network over a backhaul link or connection. Typical arrangements include a backhaul connection between a base station transceiver and a radio network controller. The base station transceiver and the radio network controller are the endpoints of the backhaul connection. In the downlink direction, the radio network controller is the backhaul transmitter and the base station transceiver is the backhaul receiver. In the uplink direction, the base station transceiver is the transmitter and the radio network controller is the receiver. In many instances, there is at least one router between a base station and the radio network controller. Many such backhaul links include T1 or E1 communication lines.

The routers aggregate or distribute traffic between the base station transceivers and the radio network controller. Typical router and backhaul link facility designs include the possibility for the backhaul link to become a bottleneck hindering the overall system throughput. When there is a large amount of backhaul communication, for example, there may be congestion on the backhaul link that does not allow for efficient communication in at least one of the uplink direction or the downlink direction between the radio network controller and the base station transceiver.

Backhaul network congestion is typically described as the situation where the amount of backhaul traffic in the downlink direction results in data packets being buffered at the output interface on the router or the radio network controller facing the base station transceiver, or in the uplink direction where the packets will be buffered at the output interface on the base station transceiver or the router facing the radio network controller. There is a point where the aforementioned buffer or buffers may overflow resulting in dropped packets and service outages. This condition is typically called backhaul network congestion. The packet drops during backhaul network congestion have a significant impact on user application performance and the overall system performance. Backhaul network congestion has been observed in arrangements of a variety of telecommunication system topologies including the commercial 1×EV-DO network and Universal Mobile Telecommunications System (UMTS) networks.

Another issue with existing systems is that the continued attempted communications and requests for service tend to create congestion problems that are not easily resolved. Telecommunication service providers and subscribers rely heavily on network availability. Subscribers rely on network availability to make personal, business and emergency calls. Service providers rely on network availability as a source of revenue and as a basis for the quality of service provided to their subscribers. As a result, if a telecommunications network is unavailable due to congestion and service outages, subscribers will not be satisfied with the lack of service, and the service provider will lose current and may lose future sources of revenue. The longer a network is down, the more money a service provider can lose and the more dissatisfied customers typically become.

### SUMMARY OF THE INFORMATION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to a more detailed description.

Provided are systems, apparatus and techniques for adjusting based on a current load a retry service request timer responsive to receipt of a service request. In one embodiment, a method comprises receiving a service request; and modifying a timer value associated with a User Equipment (UE) responsive to the service request based on a current load, the timer value indicative of a period for the UE to wait before making a next service request. System, apparatus and method embodiments provide for load control based on dynamic adjustment of service request retry timer. The timer is provided to a UE (User Equipment) for timing the next service request from the UE if the previous service request fails.

The timer value may be modified at a radio network equipment, such as a Radio Network Controller (RNC). The service request may be a Radio Resource Control (RRC) connection request. In an exemplary embodiment, the current load is based on a load condition of a Radio Network System (RNS). In another exemplary embodiment, the current load is based on a load condition of a RNC.

The method may include determining the current load. The current load may be specified based on at least one of performance measurement counter and a total number of service request establishment failures over a first time interval

In further embodiments, modifying a timer value includes modifying the timer value based on a leaky bucket algorithm. The timer value may be modified according to an adjustment step based on a leak rate over a time interval, and at least one of a high watermark and a low watermark. The leak rate may specify a number of service request establishment failures permissible over the time interval. In such an embodiment, the high watermark and low watermarks are thresholds of the number of service request establishment failures. For example, when the total number of service request establishment failures is above the high water mark, the timer value may be increased. Likewise, when the total number of service request establishment failures is below the low water mark, the timer value may be decreased.

In one embodiment, the timer value is increased when the current load is indicative of an overload condition. In another embodiment, modifying a timer value includes modifying the timer value when the service request is to be rejected. The method may include determining whether the service request is to be rejected. The method may also include communicating the timer value to the UE. The timer value may be communicated to the UE in a rejection message for the service request.

In one embodiment comprises a processor configured to receive a service request and to adjust a retry service request timer associated with a User Equipment (UE) responsive to the service request based on a current load. The current load may be specified based on at least one of performance measurement counter and a total number of service request establishment failures over a time interval. The processor may be configured to adjust the retry service request timer according to a leaky bucket algorithm.

In another embodiment, the processor may be configured to determine whether the service request is to be rejected, and to adjust the retry service request timer when the service request is to be rejected. The processor may be configured to increase the retry service request timer when the current load is indicative of an overload condition in a further embodiment. The retry service request timer also may be communicated to the UE by the processor.

Use of a fixed retry service request timer load suffers from a variety of drawbacks. For example, service requests are remade without consideration of the current condition of the telecommunication system.

The exemplary methods, apparatuses and systems in accord with the invention enable the prevention and reduction of the service outages for the serving areas of telecommunication systems due to overload. For example, adjustment of the retry timer finds utility during the recovery of an outage, during which all the wireless users are trying to come back to the wireless service. The service request message flood associated with the coming back of UEs can cause the wireless network to become overloaded and if not well managed as per the methodology disclosed herein, another outage can easily occur. In addition, such methods, apparatuses and systems enabled increased availability of telecommunication service networks, and hence customer satisfaction.

Reference herein to “one embodiment”, “another embodiment”, “an exemplary embodiment” and “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. Although various embodiments which incorporate the teachings of the present invention have been shown and described in detail herein, those skilled in the art can readily devise many other varied embodiments that still incorporate these teachings.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting, and wherein

FIG. 1 schematically illustrated a network topology with selected portions of a wireless communication system designed in accord with an embodiment of the invention;

FIG. 2 depicts a flow diagram of an exemplary routine wherein a Radio Network Controller (RNC) accepts a Radio resource Control (RRC) connection request;

FIG. 3 depicts a flow diagram of an exemplary routine wherein a RNC rejects a RRC connection request; and

FIG. 4 depicts a flow diagram of an exemplary routine according to an embodiment of the invention wherein a Radio Network Controller dynamically adjusting retry service request timer responsive to a service request based on a current load.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION

Illustrative embodiments of the invention are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the aft having the benefit of this disclosure.

Various example embodiments will now be described more fully with reference to the accompanying figures, it being noted that specific structural and functional details disclosed herein are merely representative for purposes of describing example embodiments. Various structures, systems and devices are schematically depicted in the drawings for purposes of explanation only and so as to not obscure the embodiments with details that are well known to those skilled in the art. Nevertheless, the attached drawings are included to describe and explain illustrative examples according to the principles of the present invention. Example embodiments may be embodied in many alternate forms and should not be construed as limited to only the embodiments set forth herein.

The words and phrases used herein should be understood and interpreted to have a meaning consistent with the understanding of those words and phrases by those skilled in the relevant art. Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

No special definition of a term or phrase (i.e., a definition that is different from the ordinary and customary meaning as understood by those skilled in the art) is intended to be implied by consistent usage of the term or phrase herein. To the extent that a term or phrase is intended to have a special meaning, such a special definition will be expressly set forth in the specification in a definitional manner that directly and unequivocally provides the special definition for the term or phrase.

It will be understood that, although the terms first, second, etc. may be used herein to describe various elements, these elements should not be limited by these terms since such terms are only used to distinguish one element from another. For example, a first element could be termed a second element, and, similarly, a second element could be termed a first element, without departing from the scope of example embodiments. As used herein, the term “and” is used in both the conjunctive and disjunctive sense and includes any and all combinations of one or more of the associated listed items. The singular forms “a”, “an” and “the” are intended to include the plural forms as well, unless the context clearly indicates otherwise. It will be further understood that the terms “comprises”, “comprising,” “includes” and “including”, when used herein, specify the presence of stated features, integers, steps, operations, elements, and/or components, but do not preclude the presence or addition of one or more other features, integers, steps, operations, elements, components, and/or groups thereof.

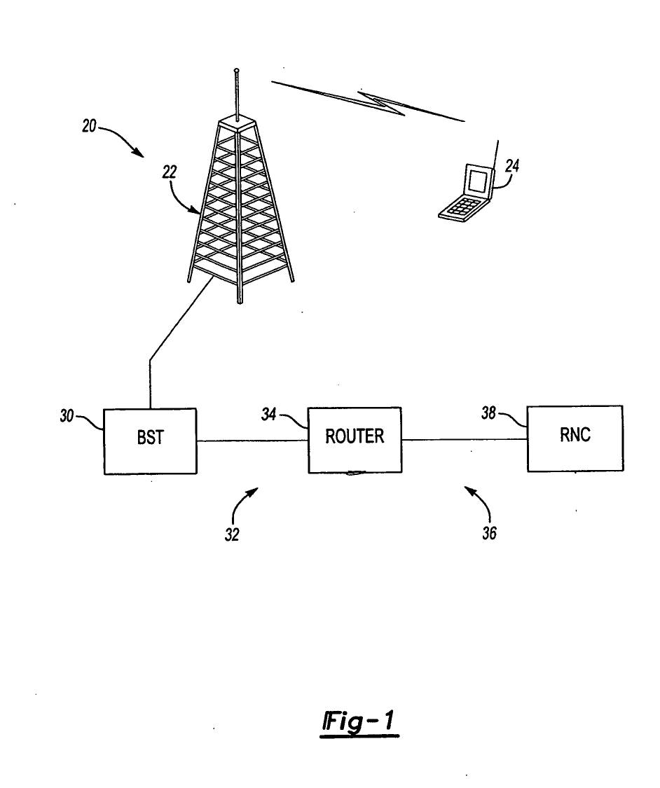

FIG. 1 schematically illustrated a network topology with selected portions of a wireless communication system designed in accord with an embodiment of the invention. A base station radio tower 22 uses an over-the-air interface for communications with one or more User Equipment or mobile stations 24. The base station radio tower 22 operates in a known manner in conjunction with base station transceiver (BST) 30. A backhaul link 32 connects the BST 30 with a router 34. Another backhaul connection 36 connects the router 34 to a radio network controller (RNC) 38. The RNC includes the functionalities for managing radio resources for one or more Node B or base stations. The connections 32 and 36 and the router 34 are part of the backhaul between the BST 30 and the RNC 38. Communications along the backhaul occur generally in a known manner. For example, the UE may make a service request which is provided to the RNC. The RNC determines whether the service request can be satisfied and responds accordingly. On many occasions, the RNC determines the requested service can be provided, responds affirmatively and the connection necessary for the desired service is established. There are situations, however, e.g., when the backhaul becomes congested and the operation of the system has become compromised, when it is preferably that the requested service not be established. In those situations, the RNC will reject the service request in which can the US will wait a period of time before re-requesting the desired service. In one embodiment, the topology illustrated illustrates a UMTS Terrestrial Radio Access Network (UTRAN) service area.

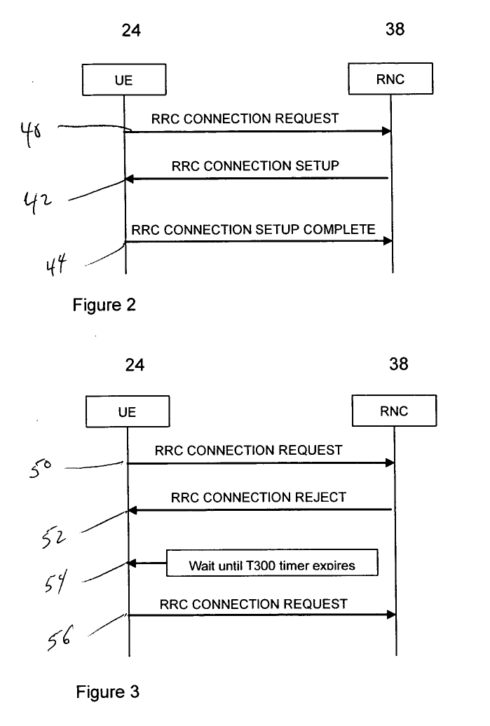

FIG. 2 depicts a flow diagram of an exemplary routine wherein a Radio Network Controller (RNC) accepts a Radio resource Control (RRC) connection request. At 40, UE 24 initiates a service request message and the service request message is communicated to RNC 38. For example, the service request message may be a Radio Resource Control (RRC) connection request. After the RNC has determined that the service request can be satisfied, at 42, the RNC responds affirmatively, for example with a RRC connection setup message. The UE proceeds to establish the connection and, at 44, returns a connection setup complete message to the RNC. Thereafter the desired service can be provided to the UE.

In situations when the backhaul becomes congested and the operation of the system has become compromised, the desired service may not be able to be or should not be provided to the UE. FIG. 3 depicts a flow diagram of an exemplary routine wherein a RNC rejects a RRC connection request. At 50, UE 24 initiates a service request message and the service request message is communicated to RNC 38. After UE sends in the RRC connection request, the retry timer is started.

The RNC responds negatively to reject the service request, at 52, after the RNC has determined that the service request can not or should not be satisfied. The message rejecting the service request may be a RRC connection request message. If no response is received by the UE when the timer expires, the UE will send the request again and restart the timer.

At 54, the UE waits a period of time before making a next service request. At the conclusion of the retry service request timer, the UE makes a next service request at 56. Thus, the US will wait a period of time before making a next service request for a desired service. UE may initially receive the timer value over the serving cell Broadcast channel. In one embodiment, the timer is the T300 timer for a UE.

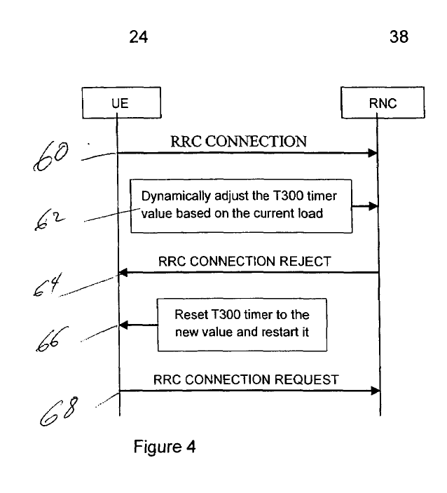

FIG. 4 depicts a flow diagram of an exemplary routine according to an embodiment of the invention wherein a Radio Network Controller dynamically adjusting retry service request timer responsive to a service request based on a current load. The retry service request timer is updated automatically based on the current load in response to a service request. Based on the current radio network load, RNC informs the UEs how long to wait before the next service request attempt.

At 60, UE 24 initiates a service request message and the service request message is communicated to RNC 38. After UE sends in the RRC connection request, the retry timer is started.

At 62, the RNC dynamically adjusts the retry service request timer value based on the current load. The current load may be the current load of the Radio Network System (RNS) in which the RNC is a member, as measured by a performance measurement counter, e.g., a total number of RRC establishment failures, maintained by the RNC over a certain time interval. A leaky bucket algorithm may be used based on the total number of RRC connection establishment failures of the RNS. The leak rate over a time interval, the high watermark and low watermark and an adjustment step may be used to govern the timer value adjustments. The leak rate specifies how many RRC connection failures are allowed over a certain time interval. The high and low water marks are two threshold values of the total number of RRC establishment failures.

The high water mark may be utilized to determine when to increase the timer value, and the low water mark for when to decrease the timer value. The adjustment step specifies the amount of adjustment when adjustment takes place. The adjustment step may be any positive value. Similarly, the thresholds against which the number of service request establishment failures is tested may be zero, any positive number or any negative number. For example, when the RNS is overloaded, and when UE service requests are rejected, it may be desirable to increase the amount of time for a UE waits before sending the next service request in order to effectively avoid or reduce the RNS service meltdown because the unsuccessful repeated service requests from the UEs only aggravate the RNS overload condition.

The leaky bucket algorithm may be applied on the current load of the RNS as well as on a per cell basis. If the RNC maintains per cell the numbers of RRC connection establishment failures, the cell based leaky bucket algorithm can achieve effective overload control for each cell site.

At 64, the RNC responds negatively to reject the service request after having determined that the service request can not or should not be satisfied. The message rejecting the service request may be a RRC connection request message which may include the updated retry service request time value. In other embodiments, separate messages rejecting the service request and updating the retry timer value may be communicated to the UE.

If no response is received by the UE when the timer expires, the UE will send the request again and restart the timer. If the UE receives the RRC connection reject response, the timer is stopped, the timer value is reset to the wait-time value contained in the reject message, and the timer started again. As opposed to conventional systems in which the timer is configured with a fixed value, which may be manually changed through system reconfiguration, embodiments of the invention dynamically change the timer value based on the current load of the RNS (Radio Network Subsystem).

Thus, at 66, the UE waits a period of time specified by the retry service timer request value before making a next service request. The timer value has been dynamically adjusted by the RNC and provided to the UE. At the conclusion of the retry service request timer, the UE makes a next service request at 68.

With increasing restrictions on accessing telecommunication providers' network/s, and the growing number of such network/s, it is desirable to have a mechanism to adjust the value of the timer automatically based on a load condition.

The method functions described above are readily carried out by special or general purpose digital information processing devices acting under appropriate instructions embodied, e.g., in software, firmware, or hardware programming. For example, methodology can be implemented as an ASIC (Application Specific Integrated Circuit) constructed with-semiconductor technology. Alternatively, the methodology according to the invention maybe implemented with FPGA (Field Programmable Gate Arrays) and other computer hardware. As such, the process steps described herein are intended to be broadly interpreted as being equivalently performed by software, hardware and a combination thereof in various alternative embodiments.

The above-described embodiments of the invention may be implemented within the context of methods, computer readable media and computer program processes. Generally speaking, methods according to the invention may be implemented using computing devices having a processor as well as memory for storing various control programs, other programs and data. The memory may also store an operating system supporting the programs. The processor cooperates with conventional support circuitry such as power supplies, clock circuits, cache memory and the like as well as circuits that assist in executing the software routines stored in the memory. As such, it is contemplated that some of the steps discussed herein as software processes may be implemented within hardware, for example as circuitry that cooperates with the processor to perform various steps. Input/output (I/O) circuitry forms an interface between the various functional elements communicating with the device.

A computing device is contemplated as, illustratively, a general purpose computer that is programmed to perform various control functions in accordance with the present invention. The invention also can be implemented in hardware as, for example, an application specific integrated circuit (ASIC) or field programmable gate array (FPGA). As such, the process steps described herein are intended to be broadly interpreted as being equivalently performed by software, hardware and a combination thereof in various alternative embodiments.

The invention may also be implemented as a computer program product wherein computer instructions, when processed by a computer, adapt the operation of the computer such that the methods and/or techniques of the present invention are invoked or otherwise provided. Instructions for invoking the inventive methods may be stored in fixed or removable media, transmitted via a data stream in a signal bearing medium such as a broadcast medium, and/or stored within a working memory within a computing device operating according to the instructions.

The particular embodiments disclosed above are illustrative only, as the invention may be modified and practiced in different but equivalent manners apparent to those skilled in the art having the benefit of the teachings herein. It is therefore evident that the particular embodiments disclosed above may be altered or modified and all such variations are considered within the scope and spirit of the invention.

What is claimed is:

1. A method comprising:
receiving a service request; and
modifying a timer value associated with a User Equipment (UE) responsive to the service request based on a current load, the timer value indicative of a period for the UE to wait before making a next service request.

2. The method of claim 1 wherein the timer value is modified at a radio network equipment.

3. The method of claim 1 wherein the timer value is modified at a Radio Network Controller (RNC).

4. The method of claim 1 wherein the service request is a Radio Resource Control (RRC) connection request.

5. The method of claim 1 wherein the current load is based on a load condition of a Radio Network System (RNS).

6. The method of claim 1 further comprising:
determining the current load.

7. The method of claim 1 wherein the current load is specified based on at least one of performance measurement counter and a total number of service request establishment failures over a first time interval.

8. The method of claim 1 wherein modifying a timer value comprises:
modifying the timer value based on a leaky bucket algorithm.

9. The method of claim 1 wherein the timer value is modified according to an adjustment step based on a leak rate over a time interval, and at least one of a high watermark and a low watermark.

10. The method of claim 1 wherein the leak rate specifies a number of service request establishment failures permissible over the time interval, and wherein the high watermark and low watermarks are thresholds of the number of service request establishment failures.

11. The method of claim 10 wherein when the total number of service request establishment failures is above the high water mark, the timer value is increased.

12. The method of claim 1 wherein when the current load is indicative of an overload condition, the timer value is increased.

13. The method of claim 1 wherein modifying a timer value comprises:
modifying the timer value when the service request is to be rejected.

14. The method of claim 1 further comprising
determining whether the service request is to be rejected.

15. The method of claim 1 further comprising:
communicating the timer value to the UE.

16. The method of claim 1 further comprising:
communicating the timer value to the UE in a rejection message for the service request.

17. A controller comprising:
a processor configured to receive a service request and to adjust a retry service request timer associated with a User Equipment (UE) responsive to the service request based on a current load.

18. The controller of claim 17 wherein the current load is specified based on at least one of performance measurement counter and a total number of service request establishment failures over a time interval.

19. The controller of claim 17 wherein the processor is configured to adjust the retry service request timer according to a leaky bucket algorithm.

20. The controller of claim 17 wherein the processor is configured to determine whether the service request is to be rejected, and to adjust the retry service request timer when the service request is to be rejected.

21. The controller of claim 17 wherein the processor is configured to increase the retry service request timer when the current load is indicative of an overload condition.

22. The controller of claim 17 wherein the processor is configured to communicate the retry service request timer to the UE.
